(19) United States
(12) Patent Application Publication
(10) Pub. No.: US 2025/0386932 A1
(43) Pub. Date: Dec. 25, 2025

(54) ARRANGEMENT CONSISTING OF A CONTAINER AND A GUIDE DEVICE

(71) Applicant: Julius Blum GmbH, Hoechst (AT)

(72) Inventors: Christian HAUER, Hoerbranz (AT); Thomas SPERGER, Hard (AT); Daniel KOHLWEISS, Hard (AT)

(21) Appl. No.: 19/305,252

(22) Filed: Aug. 20, 2025

Related U.S. Application Data
(63) Continuation of application No. PCT/AT2024/060059, filed on Feb. 20, 2024.

(30) Foreign Application Priority Data
Feb. 24, 2023 (AT) A 50129/2023

(51) Int. Cl. A47B 88/457; A47B 88/45; A47B 88/919

(52) U.S. Cl. CPC A47B 88/457; A47B 88/45; A47B 88/919

(57) ABSTRACT

An arrangement includes a container having two side walls and a container rear wall, and a guide device for movement of the container relative to a fixed furniture part. A current interface for supplying a current sink with energy is arranged on the guide device and/or the container to be coupled with the container. In the use position of the arrangement, the current interface is arranged behind the container rear wall and/or the side walls, preferably at the end side behind one of the two side walls, of the container. A current interface is arranged on the guide device so that, when mounting or demounting the container, the container can be automatically coupled to/decoupled from the current interface, and/or a current interface includes a magnet or magnetic contact with which a current sink can be connected to a current source of the fixed furniture part in a current-conducting manner.

The present application is a continuation of International Application PCT/AT2024/060059 filed on Feb. 20, 2024. Thus, all of the subject matter of International Application PCT/AT2024/060059 is incorporated herein by reference.

### BACKGROUND OF THE INVENTION

The invention relates to an arrangement consisting of a container, in particular a drawer, comprising two side walls and a container rear wall, and a guide device for the relative movement of the container with respect to a fixed furniture part, in particular a furniture carcass, wherein at least one current interface for supplying at least one current sink with energy is arranged on the guide device and/or the container in a movement-coupled manner with the container. Furthermore, the invention relates to a side wall for a container, in particular a attachment strip for the side wall, for such an arrangement and a container rear wall for a container for such an arrangement. Furthermore, the invention relates to a method for installing such an arrangement.

In the furniture industry, there has long been a need to supply containers such as drawers or shelves and their drive units with electricity in a cost-effective manner. Technical hurdles to be overcome in this regard include, in particular, the problem of a secure electrical connection for furniture parts that can be moved between a closed and an open position, as well as the fact that metallic components can endanger a user of the container or damage the container if water enters the container. Batteries that can be temporarily charged by induction in a closed position of the container have proven to be insufficient for the electrical requirements of furniture.

Such an arrangement is already known from document WO 2022/051786 A2, wherein a socket integrated into the rear wall of the container can be supplied with power from a guide device via a charging plug and a chain socket.

A disadvantage of the prior art is that mounting the container on the guide device is difficult due to the inaccessibility of the chain socket in a state in which the container is attached to the guide device or within a furniture carcass, since the container rear wall covers the chain socket and the charging plug must also be connected in a cumbersome manner with little space for the installer. Similarly, dismounting of the container is difficult because removing the container from the guide device carries the risk of irreparably damaging the charging plug connected to the rear wall of the container or the chain socket connected to the guide device. On the one hand, the mounting and dismounting process steps are complex and, on the other hand, a large number of manual steps are necessary to ensure the necessary electrical connection to the socket.

Furthermore, the socket protruding into the storage space of the container does not offer the possibility of using the power supply to drive the container via the guide device, and the power supply of the container is also limited to the socket itself. Furthermore, the chain socket is rigidly pre-assembled on the guide device, which undesirably increases the required transport volume and increases the risk of damage to the component parts during transport.

### SUMMARY OF THE INVENTION

It is therefore the object of the present invention to provide an arrangement, side wall, container rear wall and a method which are improved compared to the prior art, in which the disadvantages of the prior art are at least partially eliminated, and which is characterized in particular by a comfortable mounting of the container on the guide device as well as different current transmission from a power supply arranged on the fixed furniture part to the container and/or guide device.

Therefore, according to the invention, the at least one current interface is arranged in the use position of the arrangement behind the container rear wall and/or the side walls, preferably at the front behind one of the two side walls, of the container and:
at least one current interface is arranged on the guide device such that the container can be automatically coupled to or decoupled in an electrically conductive manner from the at least one current interface during mounting or dismounting of the container on/from the guide device due to the alignment of the at least one current interface, and/or
at least one current interface comprises at least one magnet or magnetic contact, with which at least one current sink can be electrically connected to a current source of the fixed furniture part.

This makes it possible to significantly facilitate the installation of the arrangement—in particular the container and an electric motor of a drive unit-since an installer of the arrangement can conveniently place the container on the guide device and move it in the direction of the current interface in order to automatically generate a current-conducting connection between the current source and current sinks disposed on the container. Preferably, a joining direction of the container is along the guide device and parallel (in the opposite direction) to a coupling direction of the at least one current interface. In an analogous manner, the container can be removed from the guide device with a single movement, wherein the electrically conductive connection by means of the at least one electrical interface is automatically released-without the need for intervention by a user of the furniture.

In addition, there is the positive feature that a user-friendly connection of the container and/or the guide device to a power grid on site can be efficiently ensured, wherein power from a power source (generally a power grid) can be conducted or distributed to a wide variety of power sinks-such as power sinks disposed on the container, an electric motor of a drive unit, a locking device for the container or the guide device-individually and in a versatile or modular manner by means of the at least one current interface.

For example, a power cable guided over the stationary furniture part or the guide device can be connected by means of a cable carrier by means of a magnet-assisted click connection through a magnetic contact on the back of the container to a current interface of the guide device, wherein power can be distributed to a current interface that can optionally be equipped with an electric motor or a locking device (as a current sink of the guide device) and/or to a current interface that can be automatically coupled to the container. Within the container, current can be further transported to current sinks in the container by means of current interfaces on the side walls or the rear wall of the container.

For example, three current interfaces can be provided on a connection device of the guide device, wherein an electric motor can be disposed at one current interface, the connection to the power source is generated by means of a second current interface, and current sinks of the container are supplied with power by means of the third current interface. Preferably, at least two current interfaces have a different relative orientation to the guide device, wherein, for example, one current interface can point upwards in the use position of the arrangement and another current interface can be aligned orthogonally thereto for connecting the container. The advantage is that the electrical connection of the electric motor can be independent of the electrical connection of the container (and vice versa) and/or the connection to the power source.

The container must be dimensioned wide enough to also include other movable furniture parts such as shelves or treads.

As stated at the outset, protection is also sought for a side wall for a container, in particular a attachment strip for the side wall, for such an arrangement, wherein the side wall, preferably on a side wall end face or an attachment strip end face, comprises at least one side wall current interface corresponding to the at least one current interface for current-conducting connection of the side wall to the arrangement.

As stated at the outset, protection is also sought for a container rear wall for a container for such an arrangement, wherein the container rear wall, preferably on a container rear wall end face, comprises at least one container rear wall current interface corresponding to the at least one side wall current interface for current-conducting connection of the container rear wall to the arrangement.

The side wall and/or the rear wall of the container ensure a visually appealing and efficient way of distributing power to any position in the container-without having to lay separate power cables inside or outside the container-especially after the container has been installed. For example, the side wall can be brought into contact with a power line pre-assembled in a front of the container and/or have the power line already pre-assembled.

As stated at the outset, protection is also sought for a piece of furniture with at least one such arrangement, in particular with at least one such side wall and/or one such container rear wall.

As stated at the outset, protection is also sought for a method for installing such an arrangement, wherein the following steps are carried out:
the side wall, preferably such a side wall, the container rear wall, preferably such a container rear wall, and the guide device are provided
on the guide device or the container the at least one current interface is arranged for powering the at least one current sink in such a way that, when the container moves, the at least one current interface is moved along and the at least one current interface is disposed behind the container rear wall and/or the side wall in the use position of the arrangement.

This allows a piece of furniture to be installed particularly efficiently, for example by attaching the electric motor to a drive unit for the container disposed on the guide device or by connecting it by means of magnets, and placing the container on the guide device to ensure kinematic interaction with the drive unit. Disconnecting or connecting power cables is not absolutely necessary for this.

Preferably, at least two current interfaces are provided, preferably on a connection device, and/or in the use position of the arrangement at least one current interface is oriented vertically upwards and at least one current interface is oriented orthogonally thereto, wherein preferably at least three current interfaces are provided.

This means that the power connection to the power source can be used on the one hand to supply energy to a movement technology, such as an electric motor, the guide device and on the other hand to supply energy to the current sinks of the container.

Preferably, the at least one current interface is electrically connected to at least one of the two side walls, preferably to an attachment strip of the side wall. Preferably, at least one power cable is conducted through at least one of the two side walls to a front of the container and/or to the at least one current sink and/or there is a direct power connection between the two side walls, particularly preferably via the container rear wall. This particularly favors the transmission of current to the current sinks of the container.

The at least one current interface comprises at least one magnet or magnetic contact for releasable current-conducting coupling of the at least one current sink to a current source, preferably disposed on the stationary furniture part. The at least one magnet or magnetic contact can thus have the dual function of a fixation as a connection and a current-conducting connection as a connection.

The at least one current interface is connected in a current-conducting manner to a power source disposed on the stationary furniture part by means of at least one power cable and/or cable carrier, preferably over an entire pull-out path of the container along the guide device.

Decoupling from the power source can be carried out in a user-friendly manner via the power interface—in particular via the magnetic contact or simultaneously or together with the removal of a movement technology or the container.

The at least one current interface is disposed on a connection device for an electric motor or a locking device, wherein preferably the at least one optionally present power cable and/or cable carrier is connected in a current-conducting manner to the connection device, particularly preferably by means of at least one magnet or magnetic contact.

The connection device can be used for modular connection and/or fixing of different movement technologies away from the current sinks of the container.

Preferably, the guide device comprises two carcass rails, two drawer rails mounted displaceably relative to the two carcass rails, a synchronization rod, preferably driven by an electric motor of at least one drive unit, and/or at least one toothed rack or toothed belt. The synchronization rod and the rack or toothed belt can generally also be assigned to the drive unit.

The at least one current sink is disposed, preferably directly, on at least one side wall and/or a container rear wall of the container and/or, preferably indirectly by means of at least one power cable, is electrically connected to at least one side wall and/or the container rear wall. The container itself can ensure the power distribution to the power sinks-if necessary via a power distribution system on the connection device.

It is particularly preferred that the container rear wall and/or a side wall is disposed on the container such that a current-conducting connection is established between the at least one current interface, preferably a connection device disposed on the guide device, and the container rear wall and/or the side wall, preferably from the side wall to the container rear wall, wherein preferably the current-conducting connection between the at least one current interface and the container rear wall is established by connecting the side wall, and/or the side wall, particularly preferably the attachment strip, is pivoted to the container.

A kinematic reversal with regard to the exchange of the current interfaces from the side wall to the rear wall of the container is generally also possible.

An electric motor is preferably disposed on the container and/or guide device in such a way that the electric motor is coupled, with respect to motion, to the container, and the electric motor can be or is releasably coupled to the drive unit for the container via the connection device.

An electric motor can be disposed in a modular manner as an add-on for the container, indirectly and releasably via a connection device, wherein a current can be used in a variety of ways to supply the electric motor with energy and/or the electric motor can easily be replaced or retrofitted to existing guide devices/drive units. The releasable coupling can be understood as a tool-free coupling/decoupling of the connection to the container. In addition, it is also conceivable to connect the electric motor to the drive unit in a non-releasable manner.

For example, the connection device can-alternatively or in addition to the electric motor—be equipped as a current sink, using technologies separate from the electric motor. For example, instead of the electric motor, a locking device can be coupled to the container or part of the current flowing through the connection device can be used by another current sink-such as the locking device. Current sinks apart from the electric motor can generally be supplied with current that does not flow through the connection device. In general, the connection device can be used exclusively to connect the electric motor to the drive unit or the container-without directly transferring power.

Another positive feature is that the container can be quickly and easily connected to or hung into the guide system without having to establish a direct power connection to the container. For example, the container can be provided with an attachment strip which also conducts current into and/or to the container, preferably wherein the attachment strip is in an electrically conductive connection with the connection device.

According to an advantageous embodiment of the invention, the electric motor is disposed on a rear wall of the container and/or in the use position of the arrangement behind the rear wall of the container, preferably concealed by the rear wall of the container, and/or force can be transmitted by the at least one drive unit from the electric motor to a drawer rail of a guide device disposed on the container for the relative movement of the drawer rail with respect to a carcass rail of the guide device.

The electric motor can, for example, be connected to the container by the drive unit adjacent to the container rear wall and, by a drive of a synchronization rod, transmit force to a toothed rack connected to a carcass rail (fixed to the stationary furniture part), such that a drawer rail on which the container is disposed—in particular by means of a container rail—is moved relative to the carcass rail. The container generally does not have to be in immediate or direct connection with the electric motor or the at least one drive unit, whereby optimal utilization of the structural dimensions is preferred for the ideal increase of storage space of the container for a given stationary furniture part.

If the electric motor is coupled to the container and concealed by the container rear wall, a particularly aesthetically pleasing piece of furniture can be created, since the storage space of the container and the space remaining behind the container are not visually impaired by the presence of the electric motor.

The container rear wall can generally be provided by a panel which defines the storage space at the back of the container, so that the container rear wall does not necessarily have to be the rear wall closest to the stationary furniture part.

Preferably, a physical model of the container and/or the guide device is stored in the at least one drive unit or the at least one drive unit determines such a physical model in the control and/or regulating device. Particularly preferably, the at least one drive unit comprises at least one sensor for determining a speed and/or a position of the container along the pull-out path. For example, a fail-safe determination of the position of the container relative to the stationary furniture part can be generated by a preferably unambiguous determination of relative angles of rotation of at least two gear wheels and/or rotary potentiometers as sensors. Using laser-based distance sensor systems is also conceivable.

In the prior art, synchronization rods are usually used for stabilization or to prevent tilting or one-sided stresses. Preferably, the synchronization rod is driven directly by an electric motor or the synchronization rod is used directly for driving by means of the at least one drive device-driven by the electric motor.

By a magnet or magnetic contact, a secure positioning of the electric motor on the connection device of the at least one drive unit can be ensured. The magnet or magnetic contact can also be used in a dual function to transmit current to the electric motor or other current sinks, such that the connection device acts on the one hand as a fixation of the electric motor and on the other hand as a supplier (of the electric motor or additional current sinks) with energy.

An advantageous variant of the present invention consists in that current can be supplied to the electric motor by means of the connection device, preferably by means of the at least one magnet or magnetic contact that may be present, and/or to at least one current sink that is separate from the electric motor and is preferably disposed on the container.

The connection device can thus have a dual function, wherein this dual function or only the power supply can also be used for other power sinks. The magnetic contact can form a click connection.

A cable carrier can ensure that a sufficient section of power cable is available for the power supply in every position along the pull-out path and that wear and tear on the power cable is reduced. The cable carrier can be electrically connected to the connection device using a click connection and/or a magnetic contact.

The power source can generally be located on the fixed part of the furniture or on the carcass rail or a toothed rack.

Alternatively or additionally, the current sink can generally be disposed on the guide device, wherein, for example, a lighting means disposed on the drive unit illuminates another container disposed below the container in the use position of the arrangement, provided that the other container is moved from the closed position. Detection of a movement can be generated by a position measuring device, wherein the power supply of the electric motor is particularly preferably used for the sensors and/or the lighting means.

Decoupling the container from the guide system can preferably be carried out without disconnecting a power connection. Decoupling of the electric motor can preferably be carried out by releasing the connection to the connection device (without disconnecting a power cable). Decoupling of the guide device can preferably be carried out by releasing a connection analogous to the magnetic connection of the connection device or a plug connection to the power source.

According to a preferred embodiment of the invention, the current sink is present in the form of
the electric motor for the at least one drive unit, and/or
a lighting device, preferably a lamp and/or LED strip and/or LED surface, and/or
a camera, and/or
an outlet, and/or
a preferably wireless charger, preferably an induction charger, and/or
a locking device and/or a lid for the container, and/or
a base step and/or a shelf, and/or
a sensor and/or a data transfer module, preferably arranged on a side wall of the container, and/or
a temperature control device and/or a disinfection device for the container.

In the context of the present invention, the outlet and the charger can be understood as a power sink without an electronic terminal being connected to the outlet or the charger, for example.

A camera can be used, for example, to check the condition of food-especially in a vacuum-sealed and/or temperature-controlled and/or sterilized container—or to remotely identify the contents of a container. The current sink can, for example, also be in the form of a step stool or a lid for a container, which can be blocked by means of electricity in a movement relative to the container or the guide device or can be closed substantially airtight.

A storage space of the container can be illuminated by means of a lighting device, in particular one integrated into a bottom wall or disposed above a bottom wall, wherein regions separated by a separating means can be individually illuminated, for example.

The positioning of the at least one current sink is generally arbitrary, wherein the current sink is particularly preferably located directly on the container. The power supply can be routed by means of the guide device, for example, preferably a carcass rail and/or a cable carrier, or distributed by the connection device. A separate power source for the respective power sink-such as a rechargeable battery or a battery—is generally not required, although a voltage of the power grid that is customary in the respective region-preferably 230 V—can be used.

Other possible applications for the power supply include a container lock for the guide device or the container itself, a base step, a fresh-keeping lid, etc.

Preferably, the power supply is routed by means of a side wall of the container. For example, the side wall may comprise an attachment strip for the side wall of the container, which directs current from a rear wall of the container towards the front of the container. The attachment strip can itself comprise at least one current sink-such as at least one lighting means—and, for example, comprise at least one sensor and/or at least one data transfer module for communication with an electronic means, for example to form a goods management system. The attachment strip can be electrically connected to the electric motor and/or the connection device by means of a click connection and/or a magnetic contact. The attachment strip can be connected to the container rear wall by means of a click connection and/or a magnetic contact.

A locking device to be attached to the connection device as an alternative or in addition to the electric motor can prevent an unauthorized person from gaining access to the stored goods in the storage space. A locking device such as a lock can prevent movement of the container or hinder access to the storage space. A locking device can be used to fix a shelf in the open position relative to the stationary furniture part. The locking device can generally also be used as a shock and/or earthquake protection device.

Information on the motion sequences of the container or on stored goods in the container or data regarding the electric motor or the locking device can be obtained by means of a data interface—such as the data transfer module.

By creating a power connection between the carcass rails (or toothed racks or drawer rails), a power source connected to both sides of the guide device can be dispensed with, wherein energy can be passed directly from one side of the guide device to the other side of the guide device.

The connection device allows both removal and installation of the container to be carried out in a single process step. There is no need to connect a separate power cable to the container or to the electric motor.

### BRIEF DESCRIPTION OF THE DRAWINGS

Further details and advantages of the present invention will be explained in more detail below with reference to the drawings, in which:

FIGS. 1a, 1b are perspective views of an arrangement according to a preferred embodiment, installed on a furniture carcass and insulated from the furniture carcass with an enlarged detail section in the region of a current sink,

FIGS. 2a-2g are perspective views of an arrangement according to another preferred exemplary embodiment with enlarged detail sections in the region of the connection of the electric motor,

FIG. 3 is a perspective view of an arrangement according to the embodiment of FIG. 1b with an enlarged detail section in the region of another current sink,

FIGS. 4a-4i are perspective views of illustrations of a connection of a drive unit to a guide device with enlarged detail sections in the region of a drawer rail and a carcass rail.

### DETAILED DESCRIPTION OF THE INVENTION

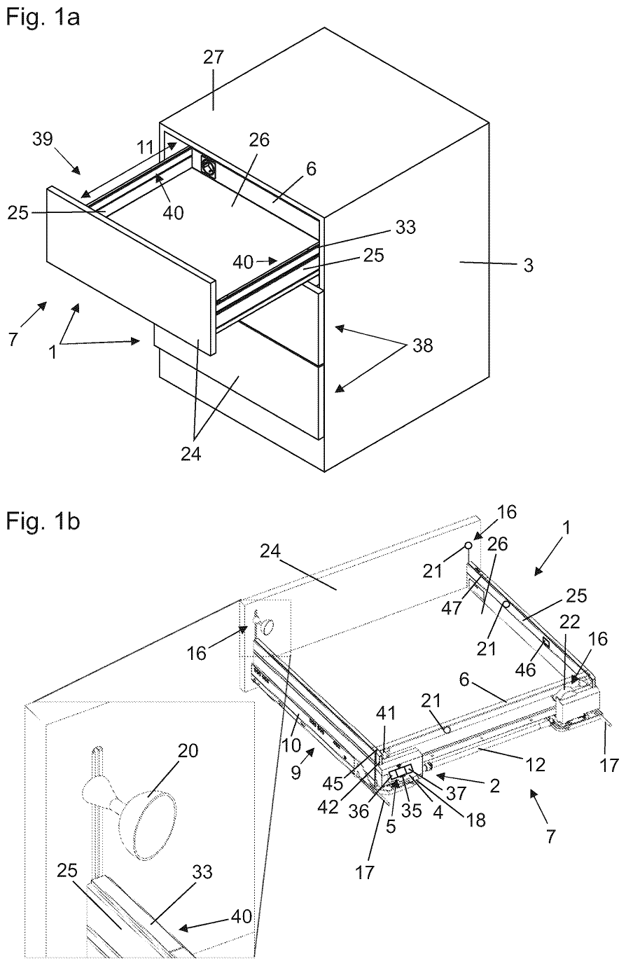

FIG. 1a shows a piece of furniture with assemblies of a container 1 in the form of a drawer and a stationary furniture part-configured as a furniture carcass.

The container 1 can be driven by a drive unit 2 from a closed position 38, an open position 39, or a position between the closed position 38 and the open position 39 completely or only partially in the direction of the open position 39 or the closed position 38.

It is apparent from FIG. 1b that the container 1 can be driven by an electric motor 4 of the drive unit 2.

The electric motor 4 is disposed on a container rear wall 6 of the container 1 and is in the use position 7 of the arrangement concealed by the container rear wall 6 behind the container rear wall 6, wherein the electric motor 4 can be slightly spaced apart from the container rear wall 6. by means of the drive unit 2, force can be transmitted from the electric motor 4 to a drawer rail 8 of a guide device 9 disposed on the container 1 for the relative movement of the drawer rail 9 with respect to a carcass rail 10 of the guide device 9.

The arrangement comprises the drive unit 2, which is for the at least partially automated movement of the container 1 relative to the stationary furniture part 3, wherein the electric motor 4 of the drive unit 2 can be supplied with 230 V and comprises an open-loop and/or closed loop control device 5 for controlling the electric motor 4.

The electric motor 4 and the drive unit 2 are disposed on the container 1 by means of a guide device 3 in such a way that the electric motor 4 is coupled, with respect to motion, to the container 1, wherein the drive unit 2 comprises a connection device 14 for the electric motor 4 by means of which the electric motor 4 can be releasably coupled to the drive unit 2. The electric motor 4 can be plugged or placed onto the drive unit 2 for fixing and connects to a power supply by means of the drive unit 2 by means of a magnetic contact 15.

The connection device 14 comprises a magnet in the magnetic contact 15 for securing the electric motor 4 to the drive unit 2, wherein the magnetic contact 15 can be provided alternatively or additionally on the electric motor 4.

On a front 24 of the container, a current sink 16 in the form of a lighting device 20 is disposed as a lamp which is supplied with current by means of an attachment strip 40 disposed on an upper side 33 of a side wall 25 of the container 1. The power of the lighting device 20 is taken from the power grid and conducted via the guide device 9.

The drive unit 2 is in a constant force-transmittable connection with the container 1 over the entire pull-out path 11 of the container 1, wherein force can be applied to the container 1 from the drive unit 2 by the electric motor 4 of the drive unit 2 across the pull-out path 11 of the container 1.

Three exemplary positions for current sinks 16 in the form of cameras 21 are schematically indicated on the container 1. The container 1 can comprise a separating means for dividing a storage space or a separate separating means can be disposed on the container 1, wherein current sinks 16 can be disposed on the separating means, which are electrically connected to the side wall 25 or the connection device 14 by means of a power cable 17.

The housing of the electric motor 4 comprises a data interface 35, wherein the data interface 35 can transmit digital data sets to a terminal device (for example a smartphone) by radio signal transmission or by cable. The housing of the electric motor 4 comprises a storage unit 36 and a computing unit 37. The memory unit 36, the computing unit 37, or the data interface 35 can generally be disposed at any position of the drive unit 2 or, for example, on the side wall 25.

A current sink 16 in the form of a sensor 45 and a current sink 16 in the form of a data transfer module 46 are disposed on the side wall 25 of the container 1. Other current sinks 16 can be provided, for example, as a lockable lid for the container, as a base step, or as a shelf. For example, the storage space of the container can be cooled or heated by means of a current sink 16 in the form of a temperature control device, wherein the storage space can be protected from contamination or a clean atmosphere can be provided for the storage space if a current sink 16 is a disinfection device. For example, the temperature control device (generally each current sink 16) can supply the storage space in sections or individually—for example depending on an open-loop and/or closed-loop control device and/or by means of a separating means.

The current sinks 16 in the form of the data transfer module 46 and the sensor are disposed directly on the side wall 25. The current sink 16 in the form of the camera 21 is indirectly connected to the power source via the container rear wall 6. The current sink 16 in the form of the lamp 20 is indirectly connected to one of the two side walls 25 and the container rear wall 6 by means of a power cable 17.

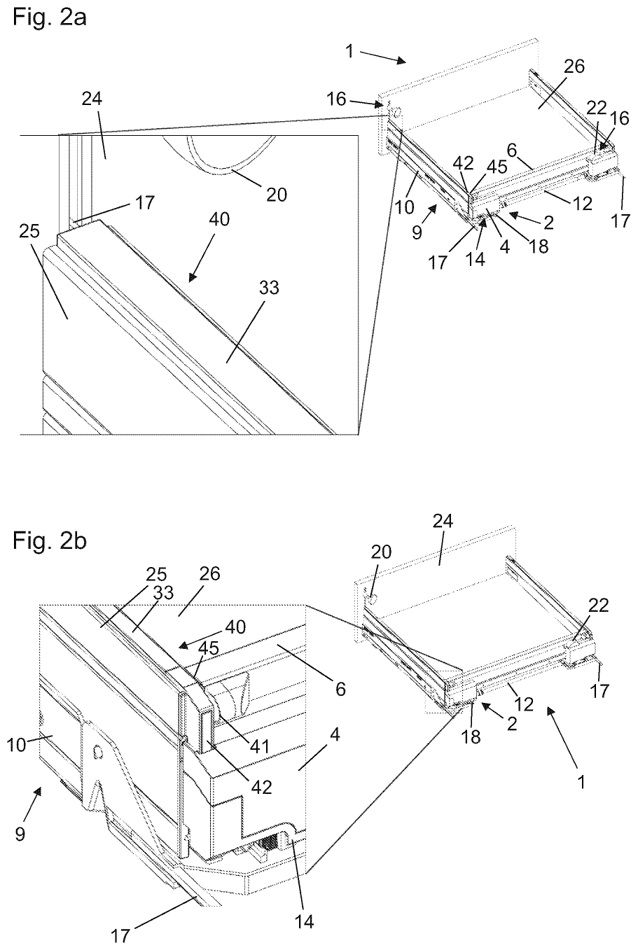

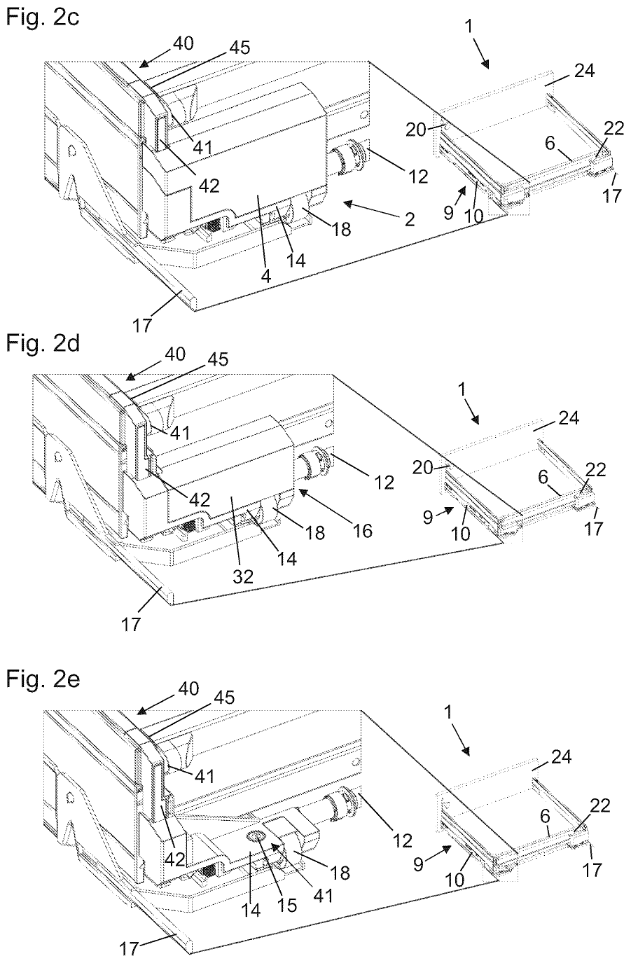

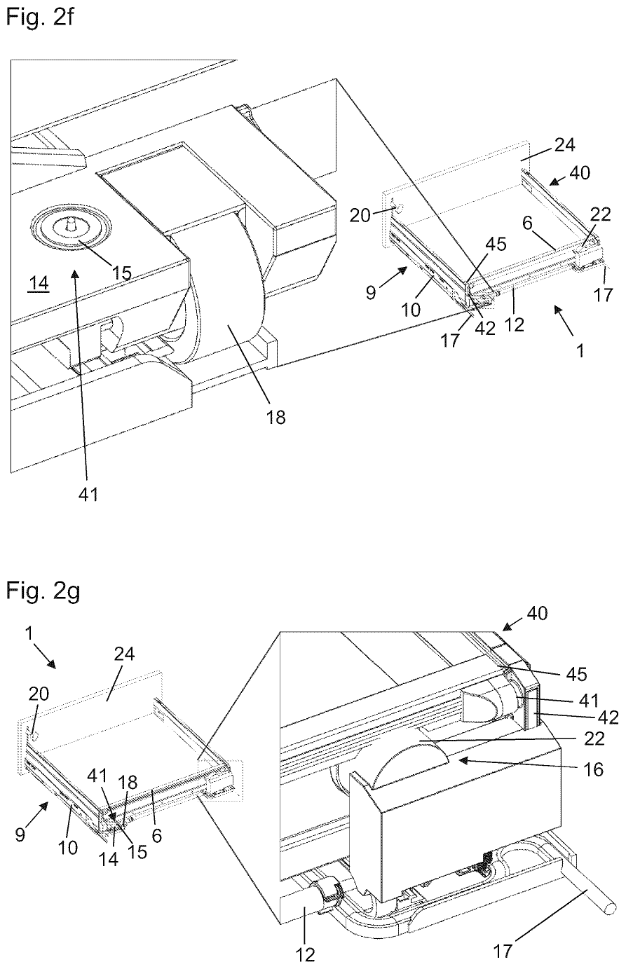

FIG. 2a shows an area between the attachment strip 40 (which can be placed thereon or attached thereto—optionally spaced apart from an upper side 33 of the side wall 25) and the lighting device 20, wherein a power cable 17 is conducted from the attachment strip 40 of the side wall 25 to the current sink 16 as a lamp in a front 24 of the container 24. In general, the power connection to the lamp can be made outside the front 24, wherein the lamp is adjustable in height relative to a bottom wall 26 along the front 24. The bottom wall 26 defines a cover wall 27 for another container disposed below the container 1, wherein the cover wall 27 can generally also be formed by the stationary furniture part 3.

FIG. 2b shows the container 1, comprising the drive unit 2 with the electric motor 4, wherein the enlarged detail section is shown in the area of the connection of the electric motor 4 to the drive unit 2 and the transmission of current coming from a power source. The current can be transmitted by means of the guide device 9 or the container 1 (the side wall 25 or the container rear wall 6).

FIGS. 2c, 2d and 2e illustrate the connection device 14 with electric motor 4, a locking device 32 alternatively connected to the electric motor 4 and, before a connection, a desired motion technology for the container. In general, the locking device 32 can also be provided in combination with the electric motor 4 or at another position of the arrangement. If manual operation of the container 1 is desired, for example as an alternative to the electric motor 4, a locking device 32 can be connected to the connection device (in a current-conducting manner).

The connection device 14 and the current interface 41 are suitable for connecting varying motion technologies or current sinks 16 to the container 1 in a modular manner or for connecting them to the container 1 in a current-conducting manner.

It is apparent from FIG. 2c that the electric motor 4 partially surrounds the side wall 25 in the area of an attachment strip 40, wherein the electric motor is electrically connected to the connection device by a magnetic contact 15 and to the attachment strip 40 of the side wall 25 by a magnetic contact 15. The attachment strip 40 is electrically connected to the rear wall 6 of the container by means of a magnetic contact 15, although this is not absolutely necessary and power transmission to the side wall 25 can also be eliminated. The current-conducting connection can generally also be present away from a magnetic connection.

It is apparent from FIG. 2d that the power cable 17 is conducted from the stationary furniture part 3 via the connection device 14 for the electric motor 4 or the locking device 32 to the locking device 32 (or an electric motor 4 disposed on the connection device 14) or is guided using the attachment strip 40 via the side wall 25 of the container 1 to the front 24 of the container 1.

The current is conducted on an upper side 33 of the side wall 25 in the use position 7 of the container 1 and at least partially within the side wall 25, wherein a current connection exists between the attachment strip 40 of the side wall 25 and the container rear wall 6, which is configured as a plug connection. If the attachment strip 40 is pivoted towards the storage space of the container, a power connection is established via the container rear wall 6 to the second side wall 25 (of the second attachment strip 40). The connection process of the power cables 17 is generally arbitrary.

The locking device 32 of the drive unit 2 is intended to inhibit a movement of the container 1 relative to the stationary furniture part 3.

FIG. 2e shows that the connection device 14 comprises a magnetic contact 15, by means of which the electric motor 4 can be disposed on the drive unit 2 and supplied with power. The magnetic contact 15 or a magnet can alternatively or additionally be disposed on the locking device 32 or the electric motor 4.

FIG. 2f shows that a power cable 17 is connected to the side wall 25 and disposed below the bottom wall 26 within a cable carrier 18 to provide a power cable section during movement of the container 1.

The arrangement comprising the two side walls 25 and the container rear wall 6 of the container 1 as well as the guide device 9 is configured in such a way that a current interface 41 (for example for the electric motor 4 or the locking device 32) is provided on the guide device 9 on the connection device 14, and four current interfaces 41 are provided on the container 1 for the two side walls 25 and the current-conducting connection of the container rear wall 6 disposed between the side walls 25, wherein in general the number of current interfaces 41 for the container 1 is arbitrary, wherein for example just current can be transferred from the current interface 41 disposed on the connection device 14 to one side wall 25. It is also conceivable to eliminate the current interface 41 of the connection device 14 and to transmit power directly to the side wall 25 or the container rear wall 6.

The current interfaces 41 are provided for supplying current sinks 16 with energy and are motion-coupled to the container 1, wherein the current interfaces 41 are disposed behind the container rear wall 6 in the use position 7 of the arrangement. The two current interfaces 41 associated with the side walls 25 are disposed on the front side behind the respective side wall 25, wherein the current interfaces 41 of the container rear wall 6 are disposed adjacent to the side walls 25.

A current interface 41 is disposed on the guide device 9 in such a way that the container 1 is automatically electrically coupled to the current interface 41 by the alignment of the current interface 41 when the container 1 is installed on or removed from the guide device 9.

The current interfaces 41 comprise a magnetic contact 15, with which current sinks 16 can be electrically connected to a power source of the stationary furniture part 3.

FIG. 2g shows a current sink 16 disposed on the container rear wall 6 in the form of an outlet 22 which protrudes through the container rear wall 6. The power for the outlet 22 can generally be obtained from the connection point 14, by means of the side wall 25 or the rear wall 6 of the container or from a power source-possibly guided by means of a power cable 17 disposed on the guide device 3. Power cables 17 can generally lead away from the outlet 22 for transferring power to other power sinks 16.

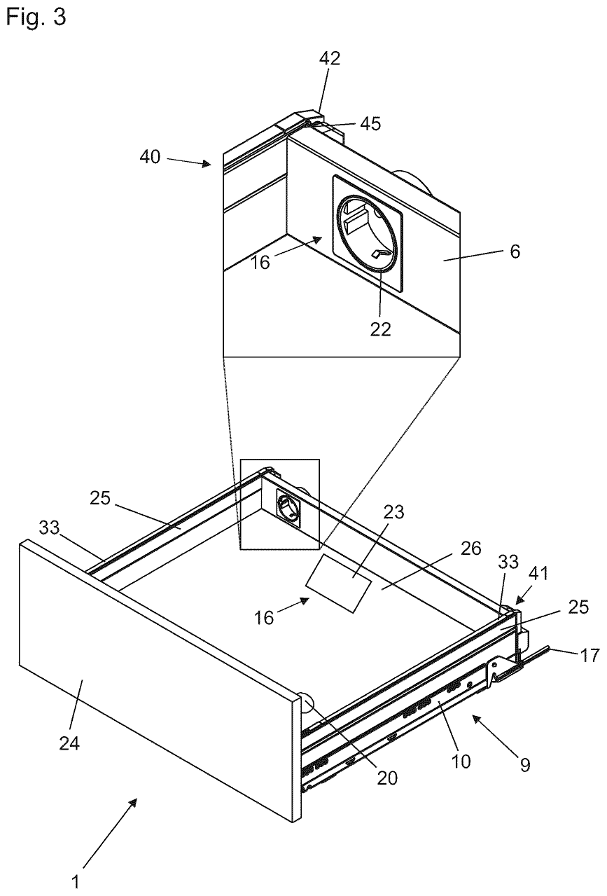

FIG. 3 schematically shows a wireless charger 23 in the form of an induction charger. For example, the area can also be used to illuminate the area of the container 1 by means of a current sink 16 in the form of an LED, an LED strip, or an LED surface.

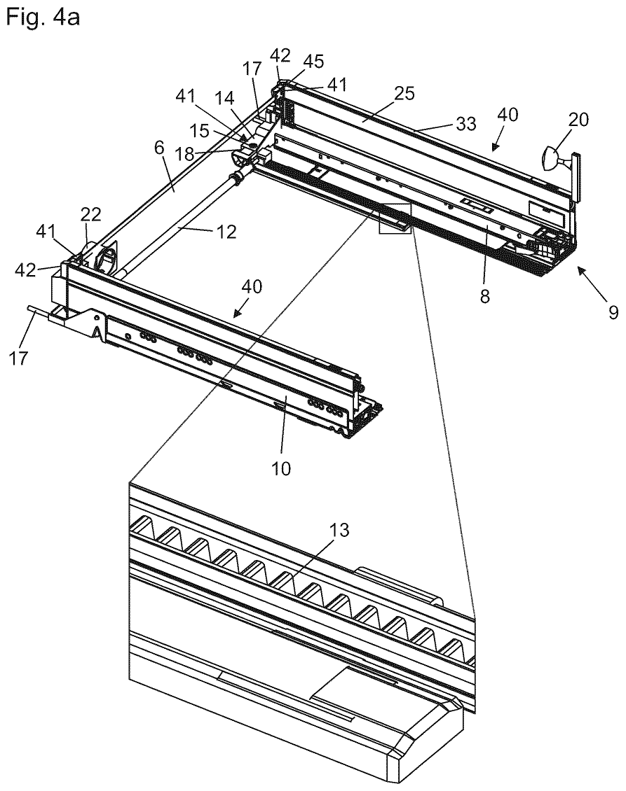

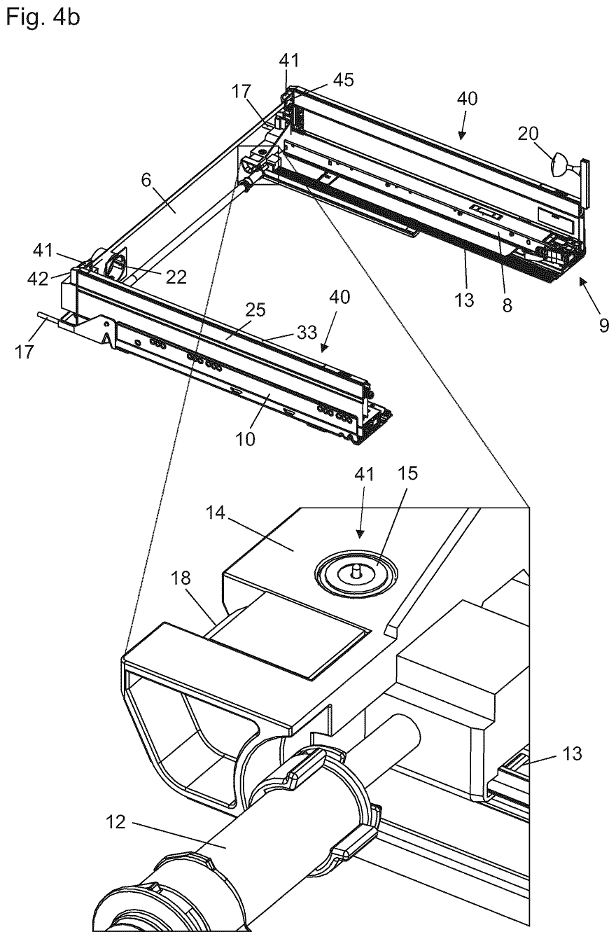

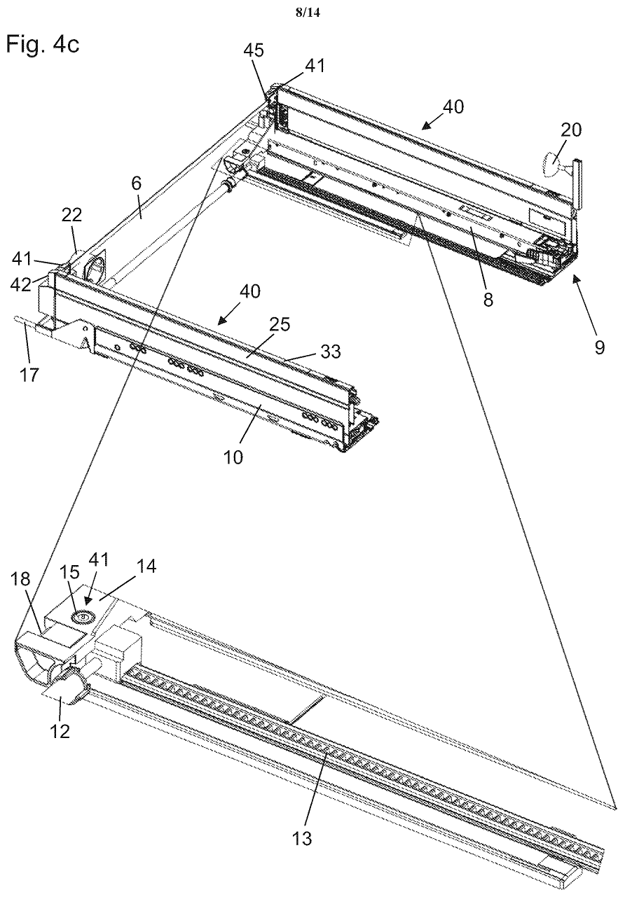

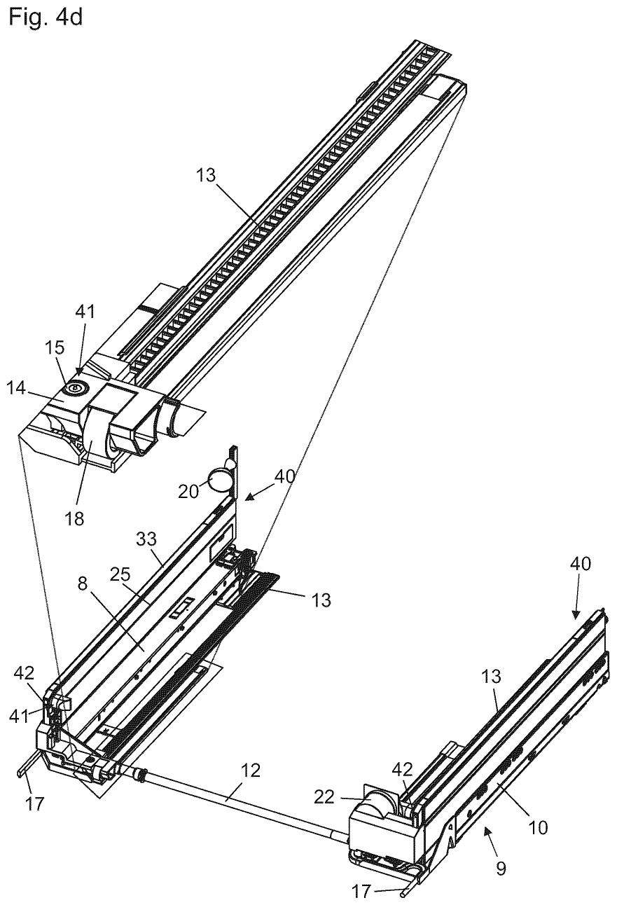

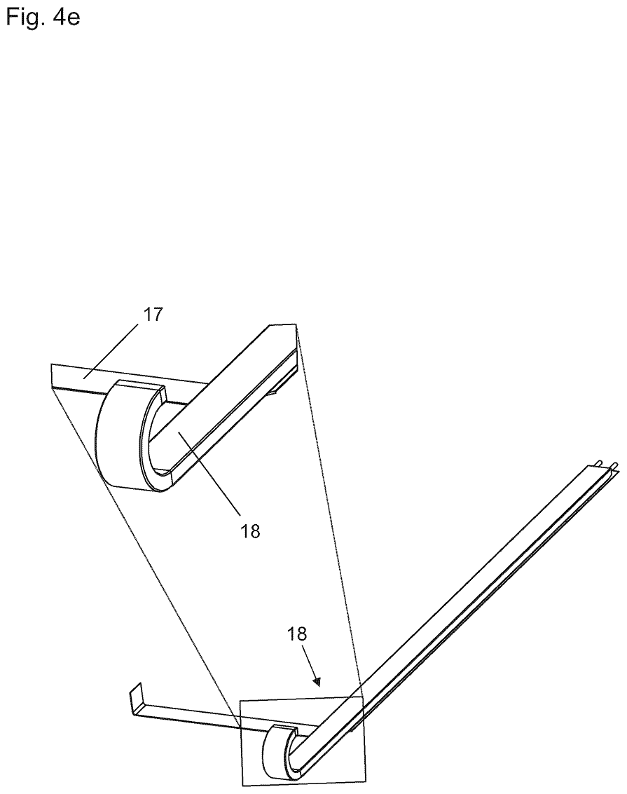

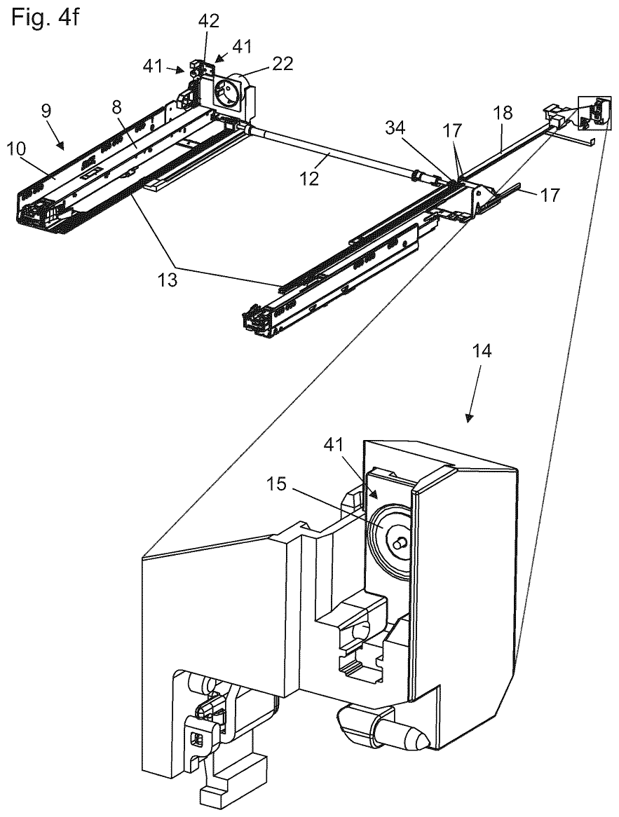

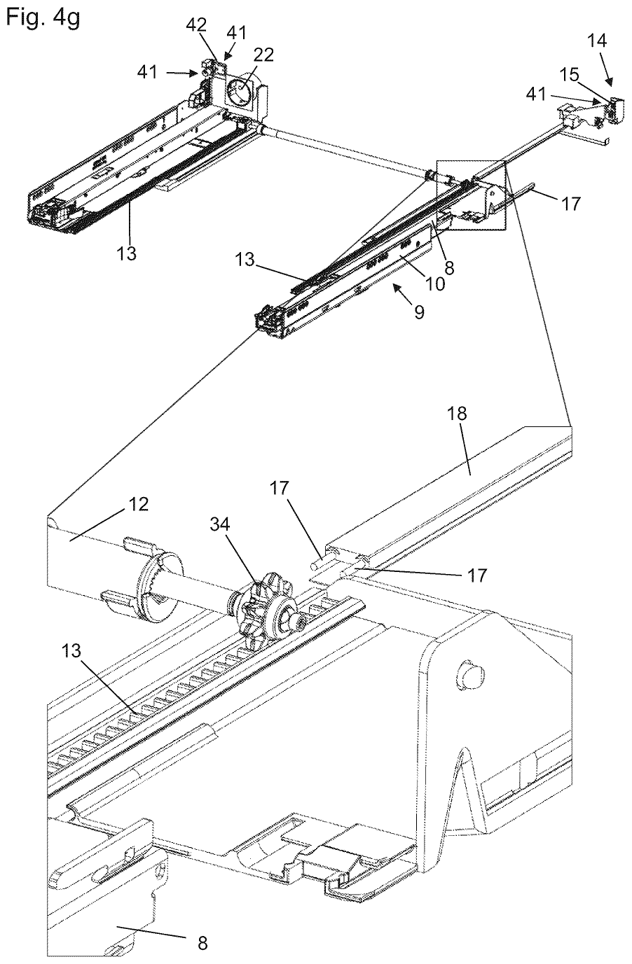

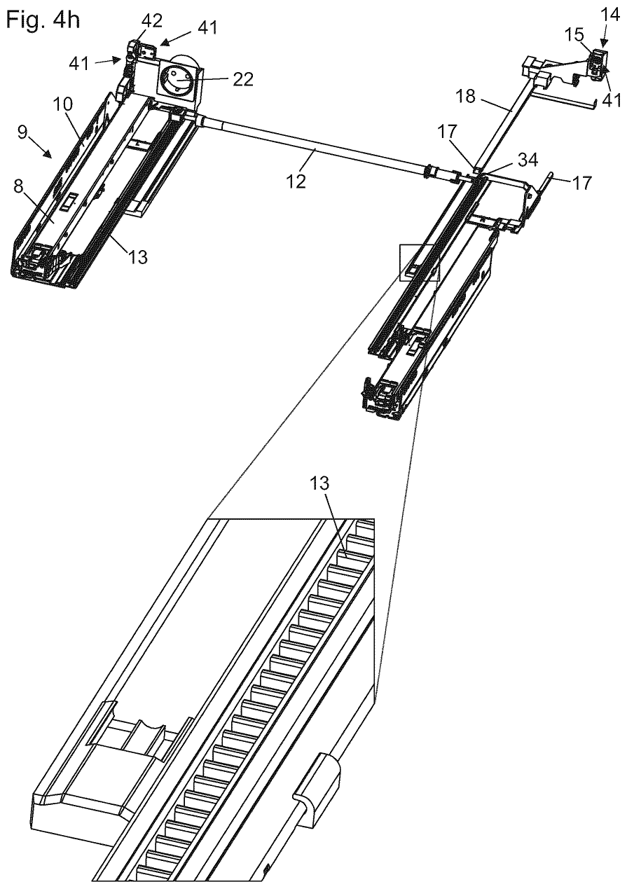

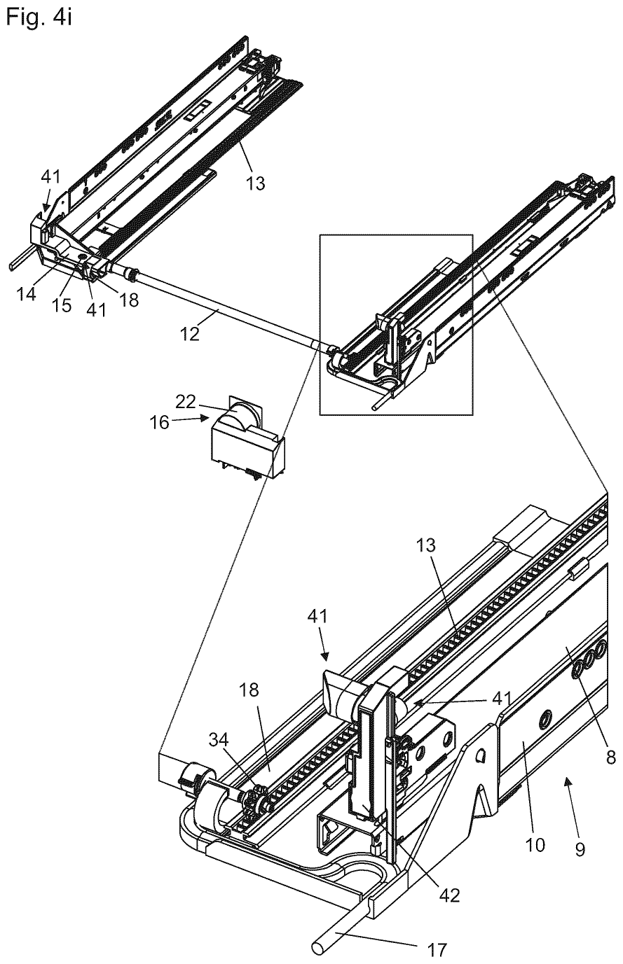

FIG. 4a shows the guide device 9 with the side surfaces 25 and the container rear wall 6 connected thereto, wherein one of two toothed racks 13 which can also be configured as a toothed belt, for example, can be seen in the enlarged detail section.

In this embodiment, two toothed racks 13 connected by means of a synchronization rod 12, disposed parallel and stationary relative to the carcass rails 10 are provided for synchronizing and laterally stabilizing a movement of the container 1 relative to the stationary furniture part 3 by means of the synchronization rod 12.

The synchronization rod 12 is driven directly by the electric motor 4 of the drive unit 2, so that the container 1 can be moved along the two toothed racks 13. The electric motor 4 of the drive unit 2 (hidden for reasons of clarity) is disposed indirectly by means of one of the two toothed racks 13 on a carcass rail 10.

FIG. 4b shows an enlarged view of the area of the connection device 14, wherein a power connection to the power system is automatically established by means of the magnetic contact 15 when the electric motor 4 is connected to the drive unit 2.

The current interface 41 of the connection device 14 is electrically connected to the current interface 41 for the side wall 25, wherein current can be passed on to the lamp 20 by means of the side wall 25. an attachment strip 40 of the side wall 25 is provided for this purpose, although this is not absolutely necessary. The side wall 25 has a side wall current interface 44 corresponding to the current interface 41 on a side wall end face 42 (in this case, an attachment strip end face) for the current-conducting connection of the side wall 25 to the arrangement.

In general, power can be supplied to the container rear wall 6 directly from the power source or indirectly by means of the current interface 41 of the connection device 14. An embodiment is shown here, wherein the current interface 41 of the attachment strip 40 (of the side wall 25) is in electrically conductive connection with the current interface 41 of the container rear wall 6. For this purpose, the container rear wall 6 has on both container rear wall end facesn 45 a container rear wall current interface corresponding to the side wall current interface for the current-conducting connection of the container rear wall 6 to the arrangement.

The power cable 17 for the current sink 16 is conducted through the side wall 25 to the front 24 of the container 1 and the current sinks 16 disposed on the container. In this embodiment, there is a direct electrical connection between the two side walls 25 via the container rear wall 26.

All current interfaces 41 comprise a magnetic contact 15 for releasable current-conducting coupling of the current sinks 16, although this is not absolutely necessary. In general, the power source is disposed on the stationary furniture part 3.

The current interfaces 41 are electrically connected to the power source by means of a power cable 17 or cable carrier 18 over an entire pull-out path 11 of the container 1 along the guide device 9.

The current interface 41 of the connection device 14 is provided for fixing the electric motor 4 or the locking device 32 by means of a magnetic connection. The connection device 14 comprises an additional current interface 41 for the current-conducting connection with the side wall 25.

The power cable 17 or cable carrier 18 is connected to the connection device 14 by means of a magnetic contact 15 in a current-conducting manner and power can be passed on to the container 1 by means of the connection device 14.

FIG. 4c differs from FIG. 4a and FIG. 4b only in the extent of the enlarged detail section.

The synchronization rod 12 is in direct contact with the connection device 14 by means of the housing and in direct force-transmitting interaction with the electric motor 4.

The cable carrier 18 is aligned along its longitudinal extent with its wider side parallel to the synchronization rod 12, such that the arrangement is particularly compact in the vertical direction and the thickness of the cable carrier 18 can be fitted below the synchronization rod 12, which reduces the risk of a collision with the synchronization rod 12.

The cable carrier 18 is disposed at a current interface 41 of the connection device 14 by means of a magnetic contact 15, wherein power is passed on to the current interface 41 for the electric motor (or the locking device 32) and (within the connection device 14) to the current interface 41 for the current sinks 16 of the container 1. The connection device 14 acts, so to speak, as a power distributor of power supplied from the power source by means of the cable carrier 18 to various power sinks 16, wherein in general the container 1 functions analogously as a power distributor by means of the other current interfaces 41.

FIG. 4d shows the guide device 9 with a view of a rear side of the container, wherein it is apparent from the enlarged detailed view that the connection device 14 is coupled, with respect to motion, to the container 1 and can be automatically coupled in a current-conducting manner to a power source of the stationary furniture part 3 by means of a power cable 17 in the cable carrier 18 when the cable carrier 18 is connected in a current-conducting manner to the power source of the stationary furniture part 3. The power source does not need to be directly accessible for connecting the electric motor 4 or installing the container 1.

The container 1 can be removed from or installed at the stationary furniture part 3 by decoupling or coupling by means of the connection device 14.

The power cable 17 and the cable carrier 18 are guided along the carcass rail 10 in connection with the toothed rack 13. The power source disposed on the stationary furniture part 3 can generally be guided on the carcass rail 10.

The connection device 14 comprises a current interface 41 for the cable carrier 18, a current interface for the electric motor 4 (or a locking device 32), and a current interface 41 for the automatic power coupling during installation of the container 1.

In use position 7 of the arrangement, a current interface 41 is oriented vertically upwards and a current interface 41 is oriented orthogonally thereto.

The side wall 25 comprises a side wall current interface for connecting to the connection device 14 for power supply by means of the power source and a current interface 41 for connecting to the container rear wall 6 by means of a container rear wall current interface of the container rear wall 6.

In FIG. 4e, the cable carrier 18, comprising the power cable 17, is shown enlarged, wherein generally only one cable carrier 18 needs to be provided and energy can be provided to the opposite side of the guide device 9 through another power cable 17 as a direct connection. The direct power connection can generally also be provided by means of the synchronization rod 12.

FIG. 4f shows that the cable carrier 18 can be removed from the guide device 9 and is in electrically conductive connection with the connection device 14 to transport energy from a conductive connection with the power source, which is guided by means of the guide device 9, to the electric motor 4. The power source can be connected in a stationary manner to the stationary furniture part 3. The power source can be configured as an outlet or as a plug connection, wherein a magnetic contact 15 is also possible.

The connection device 14 comprises another magnetic contact 15 with which power can be transmitted from the power source to the side wall 25—in particular when the attachment strip 40 is connected. Alternatively or additionally, the side wall 25 can be connected to a magnetic contact 15 of the electric motor 4.

FIG. 4g shows the components involved in the motion transmission for the translation of the force generated by the electric motor 4 by means of the toothed rack 13 to the drawer rail 8.

The synchronization rod 12 comprises two gear wheels 34, each meshing with one of the two toothed racks 13, wherein one of the two gear wheels 34 can be provided for coupling to the electric motor 4. In general, however, the design of the output from the electric motor 4 to the synchronization rod 12 is arbitrary and can be implemented by means of a belt, for example. A meshing gear wheel 34 associated with the electric motor 4 for transmitting power to the synchronization rod 12 is also possible. It is also conceivable that the electric motor 4 transmits power directly or immediately to the toothed rack 13.

FIG. 4h shows that power can be supplied to the electric motor 4 and power to the side wall 25 for current sinks 16 separate from the electric motor 4 (preferably disposed on the container 1) through the connection device 14 by means of two magnetic contacts 15. The magnetic contact 15 associated with the side wall 25 can be eliminated if power is transmitted to the side wall 25 (or the container rear wall 6) by means of the electric motor 4.

The guide device 9 comprises the two carcass rails 10, the two drawer rails 8 which can be moved relative to the carcass rails 10, the synchronization rod 12 driven by the electric motor 4 of the drive unit 2, and the two toothed racks 13, wherein the synchronization rod 12 and the two toothed racks 13 can also be associated with the drive unit 2.

FIG. 4i shows the guide device 9, wherein an adapter for the side wall 25 of the container 1 for the power supply is shown in the enlarged detail section. For reasons of clarity, the outlet 22 is removed from the intended position on the guide device 9, wherein the meshing gear wheel 34 is visible on the side of the guide device 9 opposite the electric motor 4.

The connection device 14 for the electric motor 4 can be seen at the top right of the figure, while a coupling device of the attachment strip 40 for transmitting current to the side wall 25 and the rear wall 6 of the container is shown at the top left of the figure.

Starting from a power source disposed on the stationary furniture part 3, a power cable 17 disposed on the container 1 and a power sink 16 disposed on the container 1 are provided, wherein the power cable 17 runs by means of a carcass rail 10 disposed on the stationary furniture part 3, wherein the power cable 17 can run directly between the two carcass rails 10 or toothed racks 13 in connection with the stationary furniture part 3.

An exemplary method for installing the arrangement can be explained as follows: The container 1 and the drive unit 2 are provided, wherein the electric motor 4 is releasably disposed on the connection device 14 of the container 1 by plugging it onto the same using the magnetic connection, such that the electric motor 4 is coupled with respect to motion to the container 1 during a relative movement between the container 1 and the stationary furniture part 3. Additional current sinks 16 of the container can be continuously supplied with power from the power source disposed on the stationary furniture part across the pull-out path 11.

The container 1 can be hung into the stationary furniture part 3 by means of the guide device 9 in a single installation step and automatically connected to a power source of the stationary furniture part 3, wherein the container 1 is simultaneously separated from the power source and the guide device 9 of the stationary furniture part 3 in a single removal process step.

Another exemplary method for installing the arrangement can be carried out as follows: The side wall 25, the container rear wall 6, and the guide device 9 are provided, wherein the current interface 41 for supplying the current sink 16 is disposed on the guide device 9 or the container 1 in such a way that, when the container 1 moves, the current interface 41 is moved along and the current interface 41 is disposed behind the container rear wall 6 or the side wall 25 in the use position 7 of the arrangement.

By connecting the container rear wall 6 or the side wall 25 to the container 1, a current-conducting connection can be established between the current interface 41 and the container rear wall 6 or the side wall 25—for example from the side wall 25 to the container rear wall 6. For example, the electrically conductive connection between the current interface 41 and the container rear wall 6 can be established by connecting the side wall 25, wherein the side wall 25 or an attachment strip 40 of the side wall 25 is pivoted into the container 1. Analogously, the container rear wall 6 can be connected by pivoting in order to establish a current-conducting connection in the arrangement or in the container.

1. An arrangement comprising:
a container, in particular a drawer, comprising two side walls and a container rear wall, and
a guide device for the relative movement of the container with respect to a fixed furniture part, in particular a furniture carcass,
wherein, on the guide device and/or the container, at least one current interface for supplying at least one current sink with energy is arranged so as to be coupled in movement with the container, wherein, in the use position of the arrangement, the at least one current interface is arranged behind the container rear wall and/or the side walls, preferably at the end side behind one of the two side walls, of the container, and
wherein at least one current interface is disposed on the guide device such that the container can be automatically coupled to or decoupled in an electrically conductive manner from the at least one current interface during installation or removal of the container on/from the guide device due to the alignment of the at least one current interface, and/or
wherein at least one current interface comprises at least one magnet or magnetic contact with which at least one current sink can be electrically connected to a current source of the stationary furniture part.

2. The arrangement according to claim 1, wherein in the use position of the arrangement at least one current interface is oriented vertically upwards and at least one current interface is oriented orthogonally thereto, wherein preferably at least three current interfaces are provided.

3. The arrangement according to claim 1, wherein the at least one current interface is electrically connected to at least one of the two side walls, preferably to an attachment strip of the side wall, wherein preferably at least one power cable is conducted through at least one of the two side walls to a front of the container and/or to the at least one current sink and/or there is a direct power connection between the two side walls, particularly preferably via the container rear wall.

4. The arrangement according to claim 1, wherein the at least one current interface comprises at least one magnet or magnetic contact for releasable current-conducting coupling of the at least one current sink to a current source, preferably disposed on the stationary furniture part.

5. The arrangement of claim 1, wherein the at least one current interface is connected in a current-conducting manner to a power source disposed on the stationary furniture part by means of at least one power cable and/or cable carrier, preferably over an entire pull-out path of the container along the guide device.

6. The arrangement of claim 1, wherein the at least one current interface is disposed on the connection device for an electric motor or a locking device, wherein preferably the at least one optionally present power cable and/or cable carrier is connected in a current-conducting manner to the connection device, particularly preferably by means of at least one magnet or magnetic contact.

7. The arrangement according to claim 1, wherein the guide device comprises two carcass rails, two drawer rails mounted displaceably relative to the two carcass rails, a synchronization rod, preferably driven by an electric motor of at least one drive unit and/or at least one toothed rack or toothed belt.

8. The arrangement according to claim 1, wherein the at least one current sink is disposed, preferably directly, on at least one of the two side walls and/or the container rear wall and/or, preferably indirectly by means of at least one power cable, is electrically connected to at least one of the two side walls and/or the container rear wall.

9. The arrangement according to claim 1, further comprising at least one drive unit for the at least partially automated movement of the container relative to the stationary furniture part, wherein the at least one drive unit comprises an electric motor, which can be preferably supplied with 230 V, and comprises a control and/or regulating device for controlling the electric motor.

10. The arrangement according to claim 6, wherein:
the electric motor can or is detachably coupled to the connecting device and/or
the electric motor is disposed on the container rear wall of the container and is in the use position of the arrangement concealed by the container rear wall behind the container rear wall, and/or
by means of the electric motor, force can be transmitted to a drawer rail of the guide device disposed on the container for the relative movement of the drawer rail with respect to a carcass rail of the guide device.

11. The arrangement according to claim 9, further comprising two toothed racks or toothed belts, which can be connected or are connected by a synchronization rod, preferably disposed in parallel and/or stationary relative to a possibly present carcass rail, for synchronizing and/or lateral stabilizing a movement of the container relative to the stationary furniture part, wherein the synchronization rod is drivable, preferably directly, by the electric motor of the at least one drive unit, such that the container is movable along the two toothed racks or toothed belts, wherein preferably the at least one drive unit is disposed indirectly by means of one of the two toothed racks or toothed belts on a carcass rail and/or the synchronization rod comprises a gear wheel meshing with one of the two toothed racks or toothed belts and/or the electric motor.

12. The arrangement according to claim 6, wherein the connection device is coupled, with respect to motion, to the container and/or is coupled, preferably by means of a power cable or cable carrier, preferably automatically, in a current-conducting manner to a power source of the stationary furniture part, wherein preferably the container can be removed from or installed at the stationary furniture part, particularly preferably by decoupling or coupling by means of the connection device, and/or the power cable, cable carrier, or power source is guided on a carcass rail or, if present, a toothed rack or toothed belt.

13. The arrangement according to claim 1, further comprising a power source arranged on the fixed furniture part, a power line arranged at least in regions on the container and a power sink arranged on the container are provided.

14. The arrangement according to claim 1, wherein the at least one current sink is provided in the form of:
an electric motor for a drive unit, and/or
a lighting device, preferably a lamp and/or LED strip and/or LED surface, and/or
a camera, and/or
an outlet, and/or
a preferably wireless charger, preferably an induction charger, and/or
a locking device and/or a lid for the container, and/or
a base step and/or a shelf, and/or
a sensor and/or a data transfer module, preferably arranged on a side wall of the container, and/or
a temperature control device and/or a disinfection device for the container.

15. The arrangement according to claim 1, wherein the current sink is disposed on a front and/or a container rear wall and/or a side wall and/or a bottom wall and/or a top wall of the container and/or on the stationary furniture part, wherein preferably the container and/or the stationary furniture part comprises at least one separating means for dividing up a storage space at which the current sink and/or the power cable is disposed.

16. The arrangement according to claim 1, further comprising a locking device for inhibiting a movement of the container relative to the stationary furniture part, wherein the locking device can be disposed on the connection device, preferably by the magnet or magnetic contact of the connection device, or comprises a magnet or magnetic contact for arrangement on the connection device.

17. The arrangement according to claim 1, wherein the container comprises a data interface and/or a memory unit and/or a computing unit and/or there is a, preferably direct, power connection between two carcass rails disposed on the stationary furniture part.

18. A side wall for a container, in particular an attachment strip for the side wall, for the arrangement according to claim 1, wherein the side wall, preferably on a side wall end face or an attachment strip end face, comprises at least one side wall current interface corresponding to the at least one current interface for current-conducting connection of the side wall to the arrangement.

19. A container rear wall for a container of the arrangement according to claim 1, wherein the container rear wall, preferably on a container rear wall end face, comprises at least one container rear wall current interface corresponding to the at least one side wall current interface for current-conducting connection of the container rear wall to the arrangement.

20. A piece of furniture comprising the container rear wall according to claim 19.

21. A method for installing the arrangement according to claim 1, comprising the following:
providing the side wall, a container rear wall, and the guide device; and
arranging the at least one current interface for supplying the at least one current sink on the guide device or the container in such a way that, when the container moves, the at least one current interface is moved along and the at least one current interface is disposed behind the container rear wall and/or the side wall in the use position of the arrangement.

22. The method according to claim 21, wherein the container rear wall and/or a side wall is disposed on the container such that a current-conducting connection is established between the at least one current interface, preferably a connection device disposed on the guide device, and the container rear wall and/or the side wall, preferably from the side wall to the container rear wall, wherein preferably the current-conducting connection between the at least one current interface and the container rear wall is established by connecting the side wall, and/or the side wall, particularly preferably the attachment strip, is pivoted to the container.

23. The method according to claim 21, wherein an electric motor is detachably arranged on a connecting device of the container, in particular plugged on or connected via a magnetic connection, in such a way that the electric motor is movement-coupled to the container during a relative movement between the container and a fixed furniture part, wherein it is preferably provided that the container is driven by at least one drive unit from a closed position, an open position or a position between the closed position and the open position completely or only partially in the direction of the open position or the closed position via the electric motor.

24. The method according to claim 21, wherein the container is hung into the stationary furniture part by means of a guide device and/or is connected, preferably automatically, to a power source of the stationary furniture part, wherein the container is optionally disconnected from the power source and the stationary furniture part simultaneously with a single removal process step in a subsequent method step.
